(19) United States
(12) Patent Application Publication
(10) Pub. No.: US 2009/0164775 A1
(43) Pub. Date: Jun. 25, 2009

(54) Broadband computer system

(76) Inventors: Andrew Holmes, London (GB); Andrew Hudson, North Shields (GB)

Correspondence Address: DRINKER BIDDLE & REATH (DC), 1500 K STREET, N.W., SUITE 1100, WASHINGTON, DC, 20005-1209, US

(21) Appl. No.: 12/000,965

(22) Filed: Dec. 19, 2007

(51) Int. Cl. H04L 9/00

(52) U.S. Cl. 713/155

(57) ABSTRACT

A broadband computer system comprising a network, a client computer comprising a secure log-on means, a user interaction means, a display means, processing means and client data storage means, wherein applications used on the client computer are stored on the client data storage means; a server connected to the network comprising a secure log-on verification means and server data storage means, wherein the secure log-on means communicates with the secure log-on verification means across the network to authenticate a user and, after authentication, the processing means of the client computer provides a suite of applications for use by the user and wherein any user data required by the suite of applications is provided across the network by the server data storage means.

### FIELD OF THE INVENTION

The present invention relates to a broadband computer system and, particularly, to a broadband computer system comprising a thin client computer system.

### BACKGROUND OF THE INVENTION

Computer systems are ubiquitous across all industrialised nations. Each computer system requires a user to install various applications they require to enable the particular functionality they require. Among 16 to 24 year olds the proportion of computer or Internet users is three times higher than among persons aged 55 to 74. A similar degree of inequality is observed when comparing persons with higher education with the less educated. Looking at the degree of urbanisation, penetration by computers and Internet remains lower in thinly populated, rural areas. The presence of children in a household is a major factor in access to Information and Communications Technologies (ICTs): the proportion of homes with a personal computer is 50% higher among households with children than for childless households. The same applies to home Internet connections and Broadband. Despite increasing levels of ICT usage in all sections of society, the divide is not being bridged with large proportions of the population remaining un-connected.

There are a number of core reasons that have prevented take-up by certain groups, including:
belief that the whole matter is “too complicated”;
lack of availability of a simple, relevant suite of easy-to-use, day-to-day applications;
lack of start-up knowledge;
difficulty in understanding and navigating around the de facto Operating System (Windows® ) and its associated overly-complex applications;
need for timely and comprehensive Help Desk support;
cost (hardware, software and maintenance);
concerns over reliability and what to do if anything fails, such as a hard disk;
fear over security (viruses, spyware, SPAM);
engaging in and managing Licensing Agreements;
probable need for future upgrades;
inevitable obsolescence and need for further purchase(s);
desk space; and increasingly;
carbon footprint (power consumption).
   Accordingly, an object of the present invention is to provide a computer system which obviates or mitigates one or more of the above problems.

### SUMMARY OF THE INVENTION

According to a first aspect of the present invention there is provided a broadband computer system comprising:

a network;

a client computer connected to the network comprising a secure log-on means, a user interaction means, a display means, processing means and client data storage means, wherein applications for use on the client computer are stored on the client data storage means;

a server connected to the network comprising a secure log-on verification means and server data storage means,

wherein the secure log-on means communicates with the secure log-on verification means across the network to authenticate a user and, where a user has been authenticated, the processing means of the client computer provides a suite of applications for use by the user and wherein any user data required by the suite of applications is provided across the network by the server data storage means and any data entered by the user on the client computer is transmitted for storage across the network to the server data storage means.

Preferably, the client computer and the server further both comprise respective secure communication means enabling encrypted communication between the client computer and the server.

Preferably, the secure communication means of the client computer and the server use a TLS (Transport Layer Security) based protocol for encrypted communication.

Preferably, the secure communication means of the client computer and the server use a SSL (Secure Socket Layer) based protocol for encrypted communication.

Alternatively, the client computer comprises a secure encryption means and data is encrypted by the secure communication means prior to communication with the server.

Preferably, the secure encryption means encrypts data based on a unique identifier.

Preferably, the secure log-on means is a connection for accepting a user key.

Preferably, the connection is a Universal Serial Bus (USB) connection.

Preferably, the user key is a memory storage device.

Preferably, the memory storage device is pre-loaded with an encrypted data-key.

Preferably, the encrypted data-key is used as the unique identifier.

Preferably, the server further comprises an application provision means and, where a user has been authenticated, the application provision means is enabled to provide further applications to the client computer across the network for storage on the client data storage means and provision in the suite of applications.

Preferably, the server further comprises an application management means and the suite of applications are managed and updated by the application management means as modifications to the applications are required.

### BRIEF DESCRIPTION OF THE DRAWINGS

Embodiments of the present invention will now be described, by way of example only, with reference to the drawings, in which:

FIG. 1 is a schematic diagram of a broadband computer system;

FIG. 2 is a drawing of a user key to enable secure access to a client computer of the broadband computer system;

FIG. 3 is a graphical user interface to a suite of applications available on the client computer;

FIG. 4 is a diagram of the interaction of elements of the broadband computer system.

### DESCRIPTION OF THE INVENTION

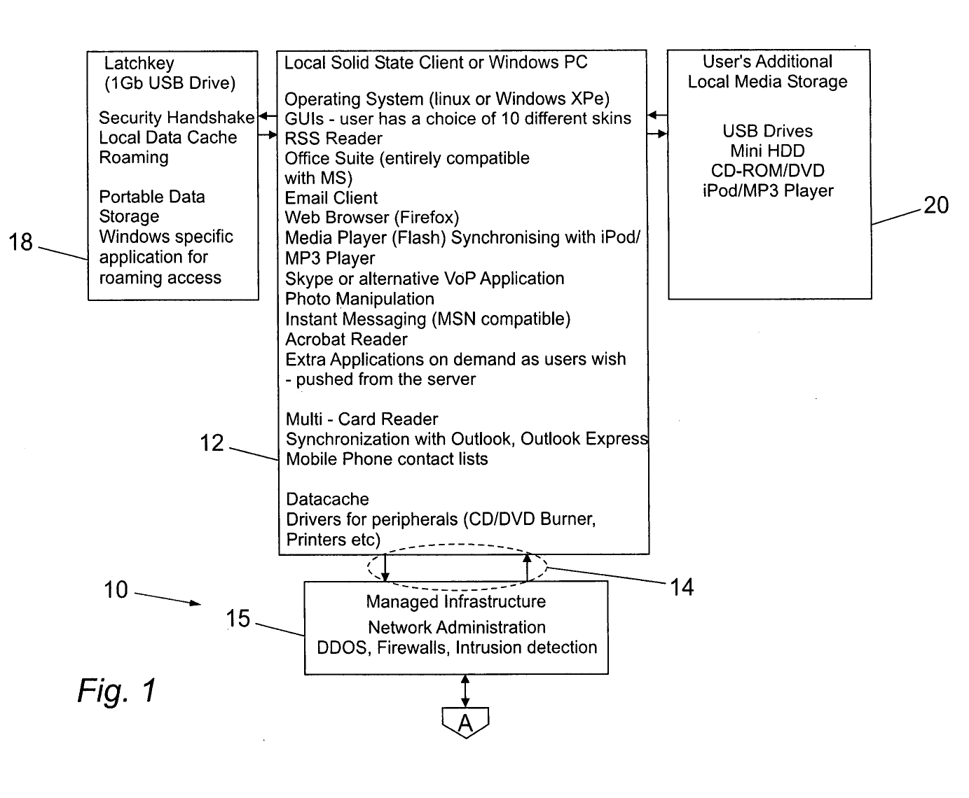

Referring to FIG. 1, a broadband computer system 10 comprises a client computer 12, a network 14 and a server 16. The client computer 12 is typically a thin client, such as a solid state computer with limited local data storage but can also be a computer having full storage and processing capabilities. The network 14 can be the Internet and/or any other appropriate network. Although the server 16 is referred to as a single server, it is also possible for more than one server to be used to provide all services and/or multiple servers each providing at least one service.

A network management means 15 provides network security to the server 16 and the client computer 12 including protecting against Distributed Denial of Service (DDoS) attacks, administering firewalls and monitoring and protecting against intrusion.

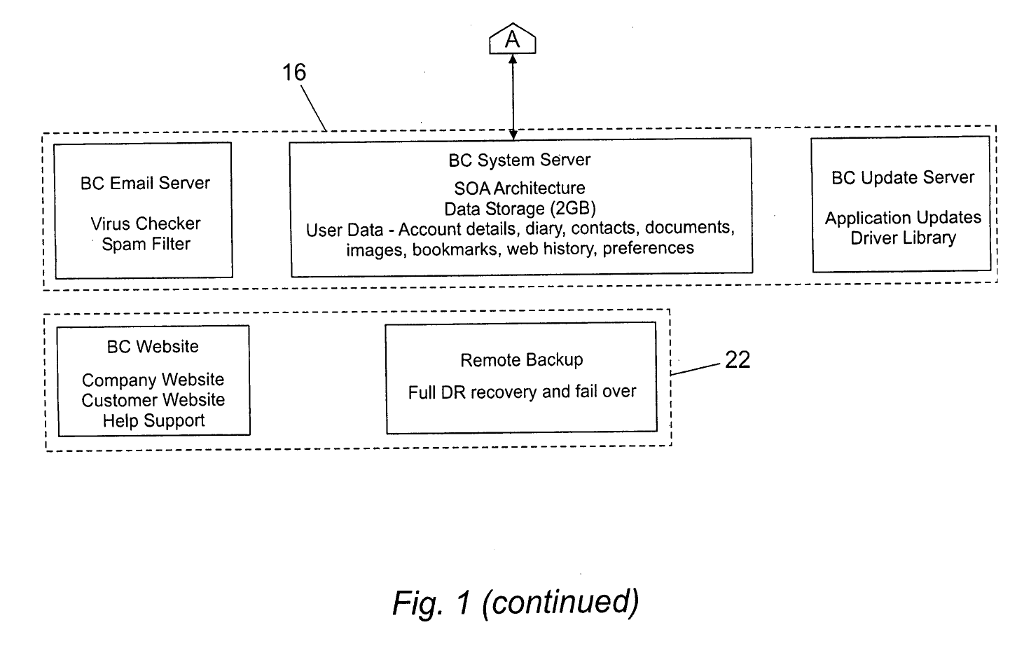

The client computer 12 has a secure log-on means, which in this particular example is a Universal Serial Bus (USB) port and associated drivers and software in combination with a USB “latch” key 18, such as the one shown in FIG. 2. The latch key 18 contains an encrypted unique identifier and, when inserted into the USB port of the client computer 12, invokes a log-on screen requiring a log-on input method such as a password, personal identification number (PIN) or other security identifier, such as a biometric input.

The client computer 12 establishes an connection with the server 16 and then the unique identifier is authenticated by the server 16 according to the log-on input method. The connection can be encrypted for security using a TLS (Transport Layer Security) or SSL (Secure Sockets Layer) based connection. Preferably, the connection is not encrypted but user data being sent over the connection is encrypted by an encryption module on the client computer 12. In this manner, although the data being transferred between the server 16 and the computer 12 is not over an encrypted connection, user data is encrypted and is stored in the server 16 encrypted.

Once the user has been authenticated, the user's data is settings and relevant data is transferred back to the client computer 12 from server data storage for display on a display screen of the client computer 12.

A user of the latch key 18 can then have their domain displayed on the client computer 12 by simple insertion of the latch key 18 and authentication of the user. The user's ‘domain’ includes all the user's preferences and data, allowing a common interface regardless of the location or computer that the user has logged into.

In this manner, the broadband computer system 10 provides a client computer 12 as a fully supported service across a network 14 providing a suite of relevant applications. Users do not have to manage a typical computer, setting up various hardware components and software applications but instead the management is performed remotely by the server 16.

Furthermore, a user of the client computer 12 can connect additional media storage 20, such as an external hard drive, USB drive, MP3 player or DVD/CD ROM. Data can then be transferred to the user's domain on the server 16 or music/video played through the client computer 12.

The server 16 can provide a suite of applications to the client computer 12 which install and are available in the user's domain. The applications can include an email client, an Internet browser, RSS (Really Simple Syndication) reader, an office suite (word processing, spreadsheet, etc.), media player, VOIP (Voice Over Internet Protocol) application, photo manipulation, instant messaging, PDF (Portable Document Format) reader, synchronisation with other devices such as mobile phones and MP3 players amongst other programs. All applications have no maintenance, upgrade or obsolescence risks as all technology upgrades are implemented at the hosting centre by the server 16. Furthermore, the client computer 12 has minimal security risks with virus checker, SPAM filters and DDOS (Distributed Denial-Of-Service) tools managed centrally.

The server 16 is backed-up to a remote back-up server 22 on regular occasions to facilitate disaster recovery. As all user data is backed up, this provides a method of reducing the likelihood of loss of data for a user. Normally, a user's own computer would only be backed when they choose to perform a back-up by writing to a CD or DVD. The broadband computer system provides a back-up of data at regular intervals, such as once a day. Furthermore, a hard disk failure in a home computer would not only require replacement or recovery of the user's personal data but also the replacement and fitting of a new drive. With the broadband computer system 10 the drives are managed at the server 16 and therefore the user might not even be aware that a drive has failed.

Multiple family or residential members, each with their own personal latch key, are able to share the same computing resource, as a personal domain is loaded depending on the identification contained on the latch key.

Furthermore, the latch key can be “nomadic”, that is interface with the client computer 12, which is designed for the broadband computer system 10, or any other Internet connected computer. The latch key can achieve this by having an automatically installing program on insertion into the computer which presents the user's domain and communicates with the server 16 as normal. Unlike today when the only means of taking a domain with you is to acquire a Laptop (plus power supply and peripherals) and be prepared to carry it around from location to location, or from country to country, the latch key can be inserted into any Internet connected computer anywhere. By logging onto the server 16 the latch key conducts the same “handshake” with the server 16 and provides the user immediate access to their domain in the same way as if they were working in their home location.

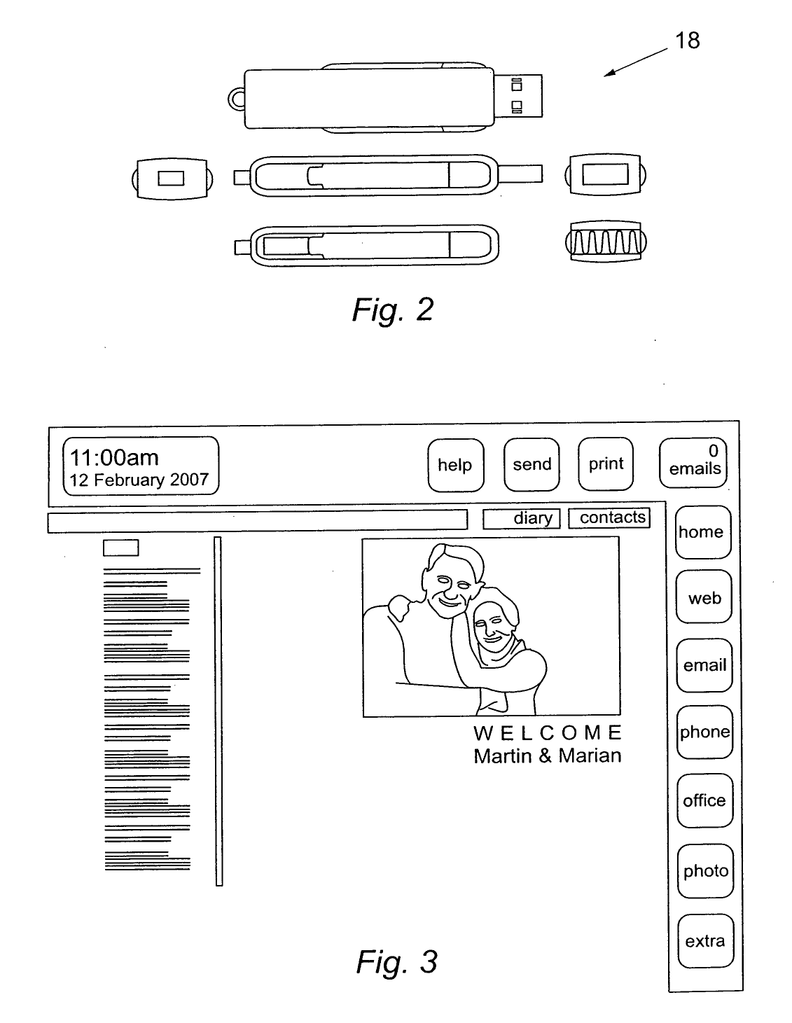

Referring to FIG. 3, a Graphical User Interface (GUI) of a domain of a user is shown. The GUI presents users with a range of applications and functions. The GUI is based on an “intuitive logic” principle and is designed to facilitate one-click access to each of the applications and functions. For example, the “Send” function links the entire application suite to e-mail; the Print function links to the entire application suite; the Help function is context-sensitive leading the user to the precise point of interest. Each application can be presented via a single click without the need (as with other computer applications) to launch a programme and then toggle a key to find the application that is needed.

Icons for the principle applications together with the primary functions are prominently displayed on the screen. The application icons are also reproduced on dedicated keys on a keyboard of the client computer 12, for ease-of-use.

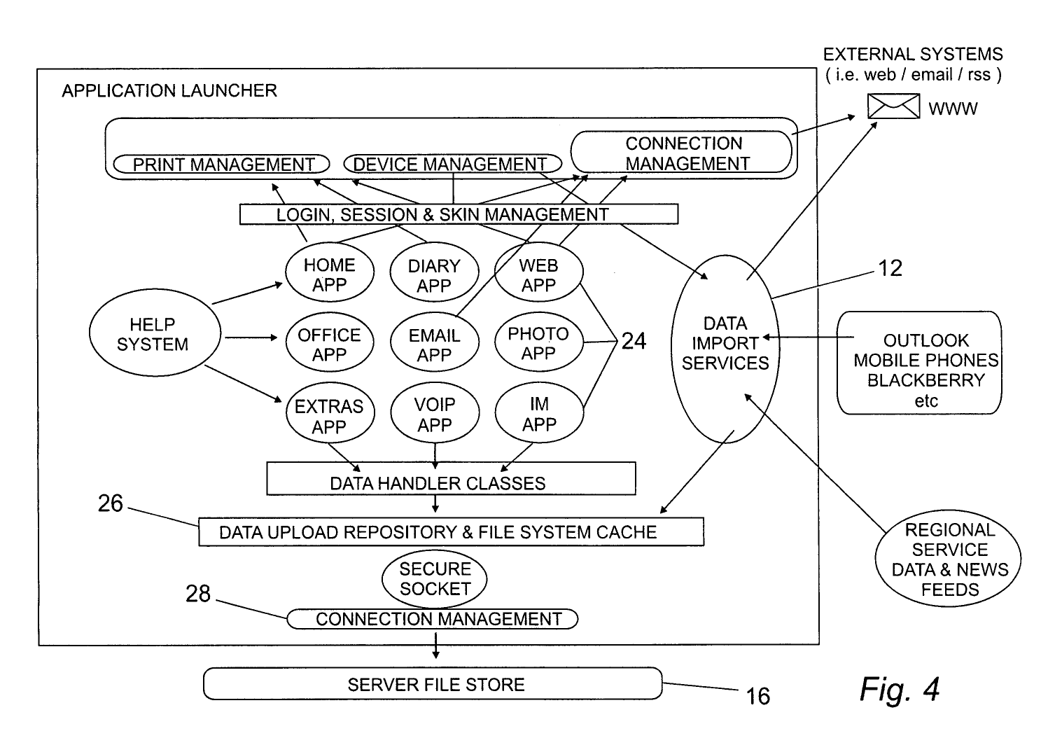

Referring to FIG. 4, a more detailed view of the client computer 12 is given in the context of the broadband computer system 10. Applications 24 resident on the client computer 12 have access to user data on the server 16 through a data cache 26 and connection management module 28. The data cache 26 avoids unnecessary data requests from the server 16 and the connection management module 28 handles encryption of user data. As mentioned above, this can either be through an encrypted connection with the server 16 or by encryption of data by the connection management module 28 prior to sending over an unencrypted connection with the server 16.

Modifications and improvements may be made without departing from the scope of the present invention.

What is claimed is:

1. A broadband computer system comprising:
a network;
a client computer connected to the network comprising a secure log-on means, a user interaction means, a display means, processing means and client data storage means, wherein applications for use on the client computer are stored on the client data storage means;
a server connected to the network comprising a secure log-on verification means and server data storage means,
wherein the secure log-on means communicates with the secure log-on verification means across the network to authenticate a user and, where a user has been authenticated, the processing means of the client computer provides a suite of applications for use by the user and wherein any user data required by the suite of applications is provided across the network by the server data storage means and any data entered by the user on the client computer is transmitted for storage across the network to the server data storage means.

2. A system as claimed in claim 1, wherein the client computer and the server further both comprise respective secure communication means enabling encrypted communication between the client computer and the server.

3. A system as claimed in claim 2, wherein the secure communication means of the client computer and the server use a TLS (Transport Layer Security) based protocol for encrypted communication.

4. A system as claimed in claim 2, wherein the secure communication means of the client computer and the server use a SSL (Secure Socket Layer) based protocol for encrypted communication.

5. A system as claimed in claim 2, wherein the client computer comprises a secure encryption means and data is encrypted by the secure communication means prior to communication with the server.

6. A system as claimed in claim 5, wherein the secure encryption means encrypts data based on a unique identifier.

7. A system as claimed in claim 1, wherein the secure log-on means is a connection for accepting a user key.

8. A system as claimed in claim 7, wherein the connection is a Universal Serial Bus (USB) connection.

9. A system as claimed in claim 7, wherein the user key is a memory storage device.

10. A system as claimed in claim 9, wherein the memory storage device is pre-loaded with an encrypted data-key.

11. A system as claimed in claim 10, wherein the client computer comprises a secure encryption means and data is encrypted by the secure communication means prior to communication with the server and the secure encryption means encrypts data based on a unique identifier and wherein the encrypted data-key is used as the unique identifier.

12. A system as claimed in claim 1, wherein the server further comprises an application provision means and, where a user has been authenticated, the application provision means is enabled to provide further applications to the client computer across the network for storage on the client data storage means and provision in the suite of applications.

13. A system as claimed in claim 1, wherein the server further comprises an application management means and the suite of applications are managed and updated by the application management means as modifications to the applications are required.
